(19) United States
(12) Patent Application Publication
(10) Pub. No.: US 2012/0094199 A1
(43) Pub. Date: Apr. 19, 2012

(54) CATALYST FOR ELECTROCHEMICAL APPLICATIONS

(75) Inventors: Ekkehard Schwab, Neustadt (DE); Sigmar Braeuninger, Hemsbach (DE); Alexander Panchenko, Ludwigshafen (DE); Claudia Querner, Ludwigshafen (DE); Oemer Uensal, Mainz (DE); Markus Vogt, Frankfurt (DE); Qinggang He, Malden, MA (US); Nagappan Ramaswamy, Malden, MA (US); Sanjeev Mukerjee, Mansfield, MA (US)

(73) Assignee: BASF SE, Ludwigshafen (DE)

(21) Appl. No.: 13/375,805

(22) PCT Filed: May 27, 2010
(86) PCT No.: PCT/EP10/57313

§ 371 Date: Dec. 2, 2011

Related U.S. Application Data
(60) Provisional application No. 61/183,251, filed on Jun. 2, 2009.

(51) Int. Cl. H01M 4/90; B01J 23/89; H01M 8/08; B01J 23/648; B01J 23/656; B01J 21/18; B01J 23/42; B01J 23/652

(52) U.S. Cl. 429/428; 502/339; 502/326; 502/313; 502/324; 502/185

(57) ABSTRACT

The invention relates to a catalyst for electro-chemical applications comprising an alloy of platinum and a transition metal, wherein the transition metal has an absorption edge similar to the absorption edge of the transition metal in oxidic state, measured with x-ray absorption near-edge spectroscopy (XANES) wherein the measurements are performed in concentrated H₃PO₄ electrolyte. The invention further relates to a process for an oxygen reduction reaction using the catalyst as electrocatalyst.

The invention relates to a catalyst for electrochemical applications comprising an alloy of platinum and a transition metal.

Carbon-supported platinum is a well-known catalyst for incorporation into gas-diffusion electrode and catalyst-coated membrane structures, for instance in fuel cell, electrolysis and sensor applications. In some cases, it is desirable to alloy platinum with other transition metals for different purposes; the case of platinum alloys with other noble metals, such as ruthenium, is for instance, well-known in the field of carbon monoxide-tolerant anode catalysts and of gas diffusion anodes for direct methanol fuel cells (or other direct oxidation fuel cells). Carbon-supported platinum alloys with non-noble transition metals are also known to be useful in the field of fuel cells, especially for gas diffusion cathodes. Platinum alloys with nickel, chromium, vanadium, cobalt, or manganese usually display a superior activity towards oxygen reduction reaction. These alloys can be even more useful for direct oxidation fuel cell cathodes since, in addition to their higher activity, they are also less easily poisoned by alcohol fuels which normally contaminate the cathodic compartments of these cells to an important extent as they can partially diffuse across the ion conducting membranes employed as the separators.

Carbon-supported platinum alloy catalysts of this type are, for instance, disclosed in U.S. Pat. No. 5,068,161 which describes the preparation of binary and ternary platinum alloys, for instance, comprising nickel, chromium, cobalt or manganese, by boiling chloroplatinic acid and a metal salt in the presence of bicarbonate and of a carbon support. The mixed oxides of platinum and of the relevant co-metals hence precipitate on the carbon support and are subsequently reduced by adding formaldehyde to the solution, followed by a thermal treatment at 930° C. in nitrogen. It can be assumed therefore that platinum and the co-metals are reduced in two distinct steps: Pt reduction is most likely completed in the aqueous phase, while other oxides, such as nickel or chromium oxide, would be converted to metal during the subsequent thermal treatment, probably above 900° C.

This explains why the degree of alloying is rather low, as evidenced by XRD scans showing that segregation occurs to an important extent, with the formation of large domains of individual elements and of a limited alloyed phase. Besides losing some of the desired electrochemical characteristics belonging to the proper platinum catalysts, this lack of structure uniformity also results in an unsatisfactory average particle size and distribution thereof. Moreover, the use of chloroplatinic acid introduces chloride ions into the system, which are difficult to completely remove and which can act as a poison for the catalyst and lower its activity. An alternative way for obtaining a platinum alloy catalyst is disclosed in U.S. Pat. No. 5,876,867, wherein a carbon-supported platinum catalyst is treated with a soluble salt of the second metal (for instance cobalt nitrate) in an aqueous solution, dried and heated at high temperature in an inert gas, in vacuo or a stream of hydrogen gas to induce alloy formation. Also, in this case, however, the degree of alloying is typically insufficient. Besides the poisoning effect, the residual chloride ions which may be present on the initial carbon-supported platinum catalyst (which is again typically produced through the chloroplatinic route) can somehow hinder the formation of a homogeneous alloy between Pt and the second metal.

A carbon supported platinum alloy electro catalyst which can be used in a gas diffusion electrode or in a catalyst-coated membrane structure in a fuel cell is known, for example, from WO 2006/056470. The catalyst is obtained by simultaneously reducing in situ-formed platinum dioxide and at least one transition metal hydrous oxide on a carbon support. As a transition metal, for example, nickel and chromium are mentioned.

It is an object of the present invention to provide a catalyst for electrochemical applications having an improved activity and stability compared to the catalysts as known from the art.

This object is achieved by a catalyst for electrochemical applications comprising an alloy of platinum and a transition metal, wherein the transition metal has an absorption edge similar to the absorption edge of the transition metal in an oxidic state measured with x-ray absorption near-edge spectroscopy (XANES) in situ, wherein the measurements are performed in concentrated H₃PO₄ electrolyte. The measurements are performed preferably between 0 and 1.5 V versus a reversible hydrogen electrode. This I in direct contrast to the results obtained from prior art as mentioned above.

Preferably, the transition metal is selected from the group consisting of nickel, chromium, vanadium, cobalt, manganese, iron and mixtures or alloys thereof. Particularly, the transition metal is nickel or cobalt, for example nickel.

The catalyst according to the invention shows a better activity than a catalyst comprising an alloy of platinum and a transition metal as known from the art. A further advantage of the inventive catalyst is that it has better resistance to corrosion than the known catalysts. Particularly the resistance to corrosion in presence of phosphoric acid (H₃PO₄) is reduced compared to the known catalysts.

The inventive catalyst comprising an alloy of platinum and a transition metal is characterized by an absorption edge of the transition metal being similar to the absorption edge of the transition metal in an oxidized state measured with x-ray absorption near-edge spectroscopy (XANES). The measurements are performed in concentrated phosphoric acid electrolyte. According to the present invention the absorption edge measured with x-ray absorption near-edge spectroscopy is the K-edge. In the case of nickel as transition metal, the measurements are performed preferably at 0.54 V versus a reversible hydrogen electrode.

The determination of the K-edge structure by x-ray absorption spectroscopy (XAS), especially the near-edge spectra, referred to as the x-ray absorption near edge structure (XANES) is well known to those skilled in the art.

X-ray absorption spectroscopy (XAS) is an element specific technique involving the excitation of tightly bound core level electrons by incident x-ray photons from a high intensity, energy tunable x-ray source such as the synchrotron. XAS spectra have two parts, (i) the x-ray absorption near edge spectra (XANES) and (ii) the extended x-ray absorption fine structure (EXAFS). XANES region consists of localized transitions caused by the excitation of core level electrons to the low lying empty states near the Fermi level whereas the EXAFS region is a photoelectron interference phenomenon caused by the interaction of outgoing photoelectron with the small fraction of the backscattered photoelectrons from the nearest atomic neighbors. XANES region can yield information regarding the electronic properties of the absorber atom and surface adsorbates whereas the EXAFS can yield information regarding the structural and geometric properties (bond lengths and coordination numbers) of the system under investigation.

Critical advantage of this spectroscopy is that it enables element specificity with in situ capability. Hence electrochemical cells are designed to emulate actual fuel cell operating conditions while simultaneously allowing XAS spectra to be measured. These are typically done using half cell mode with the actual working electrode being the electrode of choice (cathode or anode) with counter and reference electrode chosen appropriately. In some cases complete fuel cell configurations are also invoked. All fuel cell operating parameters are employed such as gas diffusion electrodes, membrane separators, inlet gas partial pressure and temperature etc. Information thus derived is true manifestation of electrocatalyst behaviour in real life operating condition.

In a preferred embodiment the bond length of the transition metal in the catalyst corresponds to the bond length of the transition metal in an oxidized state. In the case of nickel, the bond length is in the range from 1.5 to 1.8 Å. The bond length can be determined for example by using extended x-ray absorption fine structure (EXAFS) measurement. The bond length of the transition metal in the catalyst according to the invention corresponds with the shorter bond length of the transition metal in oxidized state.

In a preferred embodiment the molar ratio of platinum to transition metal is in the range from 1 to 4, preferably in the range from 2 to 3.5, for example 3.

Generally an alloy of platinum and a transition metal is composed of crystallites, wherein the crystallites can have different compositions. Several crystallites are bonded together forming particles of the alloy. The crystallites in the alloy have preferably an average size of less than 5 nm. The size of the crystallites can be determined for example by powder diffraction.

The catalyst according to the invention can be produced for example by a process comprising the following steps:
a) Mixing of a catalyst comprising the platinum with a thermally decomposable compound comprising the transition metal to give an alloy precursor,
b) heating of the alloy precursor in a reducing atmosphere.

The catalyst can be produced either in a batch process or in a continuous process. If the catalyst is produced in a continuous process, a continuously operated furnace is used for heating of the alloy precursor. Continuously operated furnaces which be can used are, for example, rotary kilns or belt calciner.

The catalyst comprising the platinum is in the form of, for example, metallic powder. Besides metallic powder it is also possible to use a catalyst comprising a support. The advantage of a catalyst having a support is that a large specific surface area can be obtained, by which a sufficiently good catalyst activity can be achieved. To achieve the large surface area, the support is preferably porous.

When the catalyst is applied to a support, individual particles of the catalyst material are generally comprised on the support surface. The catalyst is usually not present as a contiguous layer on the support surface.

The support is generally a catalytically inactive material, to which catalytically active material has been applied or which comprises the catalytically active material. Suitable catalytically inactive materials which can be used as supports are, for example, carbon blacks, or ceramics. Further suitable support materials are, for example, tin oxide, preferably semiconducting oxide, γ-aluminium oxide, which may be carbon coated, titanium dioxide, zirconium dioxide or silicon dioxide, with the latter preferably being present in finely divided form having a primary particle diameter of from 50 to 200 nm. Tungsten oxide and molybdenum oxide are also suitable and these can also be present as bronzes, i.e. as substoichiometric oxide. Further suitable supports are the carbides and nitrides of metals of transition groups IV to VII of the Periodic Table of the Elements, preferably of tungsten and of molybdenum.

However, carbon is particularly preferred as support material. An advantage of carbon as support material is that it is electrically conductive. When the catalyst is used as electrocatalyst in a fuel cell, for example as cathode of the fuel cell, it is necessary for it to be electrically conductive in order to ensure the function of the fuel cell. The carbon used as support can be present as, for example, carbon black, graphite or nanostructured carbon. Suitable carbon blacks are, for example, Vulcan XC72 or Ketjen black EC300. If the carbon is present as nanostructured carbon, preference is given to using carbon nanotubes. To produce the catalyst, the platinum is applied to the support material.

When the catalyst comprising the platinum further comprises a support, the platinum is usually firstly deposited on the support. This is generally carried out in solution. It is possible, for example, for the metal compounds to be present in solution in a solvent for this purpose. The metal can be present in covalent, ionic or complexed form. Furthermore, it is also possible for the metal to be deposited reductively, as precursor or by precipitation of the corresponding hydroxide by means of alkali. Further possibilities for deposition of the platinum are impregnation with a solution comprising the platinum (incipient wetness), chemical vapor deposition (CVD) or physical vapor deposition (PVD) processes and also all further processes known to those skilled in the art by means of which metal can be deposited. Preference is given to firstly precipitating a salt of the platinum. The precipitation is followed by drying and heat treatment to produce the catalyst comprising the platinum.

The production of such supported or unsupported catalysts comprising the platinum is known and corresponding catalysts can be procured commercially.

When the catalyst comprising the platinum which is used in step (a) is in unsupported form, the platinum is preferably present as powder having a particle size in the range from 1 to 200 μm. In this case the platinum has primary particle sizes in the range from 2 to 20 nm. However, the powder of the platinum can also comprise further, catalytically inactive constituents. These serve, for example, as release agents. Suitable materials for this purpose are, for example, all materials which can also be used as catalyst supports.

The transition metal is preferably present as metal-organic complex. Preferred ligands for formation of the metal-organic complex are olefins, preferably dimethyloctadiene, aromatics, preferably pyridine, 2,4-pentanedione. Preference is also given to the transition metal being present in the form of a mixed cyclopentadienyl-carbonyl complex or as pure or mixed carbonyl, phosphane, cyano or isocyano complex.

Preference is given to the transition metal being present as metal organic complex with acetylacetonate or 2,4-pentanedione as ligand. The transition metal is preferably present in ionic form.

To mix the transition metal with the catalyst comprising the platinum it is preferred that the thermally decomposable compound comprising the transition metal is present in dry form. However, as an alternative, it is also possible for the thermally decomposable compound to be present as a solution in a solvent. The solvent is in this case preferably selected from the group consisting of ethanol, hexane, cyclohexane, toluene and ether compounds. Preferred ether compounds are open-chain ethers, for example diethyl ether, di-n-propyl ether or 2-methoxypropane, and also cyclic ethers such as tetrahydrofuran or 1,4-dioxane.

If the thermally decomposable compound comprising the transition metal is present in solution in a solvent, the mixture of the catalyst comprising the platinum and the metal-organic compound or the metal complex is dried before the heat treatment in step (b). Drying can be carried out at ambient temperature or at elevated temperature. If drying is carried out at elevated temperature, the temperature is preferably above the boiling point of the solvent. The drying time is selected so that the proportion of solvents in the mixture of the catalyst comprising the platinum and the complex after drying is less than 5% by weight, preferably less than 2% by weight.

The mixing of the catalyst comprising the platinum and the complex comprising the transition metal is effected by any method known to those skilled in the art for the mixing of solids. Suitable solid mixers usually comprise a vessel in which the material to be mixed is moved. Suitable solids mixers are, for example, paddle mixers, screw mixers, hopper mixers or pneumatic mixers.

When the thermally decomposable compound is present in solution in a solvent, the mixture of the catalyst comprising the platinum and the dissolved complex is preferably produced by customary dispersion process known to those skilled in the art. This is carried out using, for example, a vessel in which fast-rotating knives or blades are comprised. An example of such an apparatus is an Ultra-Turrax®.

However, it is particularly preferred that the catalyst comprising the platinum is still free-flowing. This is generally the case when the catalyst has a residual moisture content of up to 50% by weight of water. The residual moisture content of the catalyst comprising the platinum is particularly preferably in the range from 20 to 30% by weight of water. As a result of the water content, the mixture of the catalyst comprising the platinum and the complex comprising the transition metal remains free-flowing. This is an essential prerequisite for satisfactory operation of, in particular, a rotary tube furnace used as continuously operated furnace. The residual moisture content of the catalyst comprising the platinum is obtained, for example, by drying in air during production.

To produce an alloy of the platinum and the transition metal, the powder produced in step (a) by mixing the catalyst comprising the platinum with the thermally decomposable compound comprising the transition metal is heated. For this purpose, the mixture produced in step (a) is brought to a temperature in the range from 90 to 900° C., preferably in the range from 350 to 900° C., more preferably in the range from 400 to 850° C. and in particular in the range from 400 to 650° C., in a continuously operated furnace. As a result of heating, the complex is decomposed and the metal bound therein is liberated. The transition metal combines with the platinum. This forms an alloy in which disordered metal crystallites are present side by side. The individual metal crystallites generally have a size of less than 5 nm.

In a preferred embodiment, heating is carried out in two temperature stages, with the temperature of the first temperature stage being lower than the temperature of the second temperature stage. It is also possible for heating to be carried out in more than two temperature stages. Here, the temperature of the subsequent temperature stage is in each case higher than the temperature of the preceding temperature stage. However, preference is given to carrying out heating in two temperature stages.

When heating of the alloy precursor in step (b) is carried out in two temperature stages, preference is given to the temperature of the first temperature stage being in the range from 300 to 500° C., preferably in the range from 350 to 450° C. and in particular in the range from 370 to 430° C., and the temperature of the second temperature stage being in the range from 500 to 700° C., more preferably in the range from 550 to 650° C. and in particular in the range from 570 to 630° C. The temperature of the second temperature stage is preferably at least 100° C. higher, more preferably at least 150° C. higher, than the temperature of the first temperature stage.

The residence time in the furnace, preferably in the continuously operated furnace in step (b) is preferably in the range from 30 minutes to 10 hours, more preferably in the range from 45 minutes to 5 hours and in particular in the range from 1 hour to 2 hours.

The heating of the alloy precursor in step (b) is preferably carried out under reducing atmosphere. The reducing atmosphere preferably comprises hydrogen. The proportion of hydrogen depends on the composition of the catalyst to be produced. The proportion of hydrogen in the reducing atmosphere can be up to 100% by volume. Preference is given to using H₂/N₂ gas atmosphere in which the concentration of hydrogen is usually less than 30% by volume, generally less than 20% by volume. The proportion of hydrogen in the reducing atmosphere is particularly preferably in the range from 4 to 10% by volume, in particular about 5% by volume.

Apart from hydrogen, the reducing atmosphere preferably comprises at least one inert gas. The reducing atmosphere preferably comprises nitrogen. However, as an alternative, it is also possible to use, for example, argon in place of the nitrogen. It is also possible to use a mixture of nitrogen and argon. However, preference is given to nitrogen.

It is particularly preferred for the reducing atmosphere not to comprise any further constituents in addition to the hydrogen and the inert gas. However, the presence of traces of further gases, for example due to the method of gas production, should not be ruled out.

After heating to form the alloy in step (b), a passivation is preferably carried out. For this purpose, the alloy produced is, for example, cooled to ambient temperature under an inert atmosphere. The inert atmosphere is preferably a nitrogen or an argon atmosphere. It is also possible to use a mixture of nitrogen and argon. The alloy produced in step (b) can also be introduced, for example, into a charge of water in order to effect passivation after leaving the continuously operated furnace.

Preferably, in a terminal step the catalyst is subject to an acid-treatment. To perform the acid-treatment, the catalyst is treated for 30 min to 2 h, preferably 45 min to 1.5 h, for example for 1 h at a temperature lower than the boiling point of the used acid and above 50° C., preferably in the range from 75 to 95° C. in a mineral acid with a concentration smaller than 2M. Preferably, the mineral acid is sulphuric acid. In a following step the catalyst is filtrated and washed in demineralised water. Finally the catalyst is dried until required residual moisture content is achieved.

Further characteristics of precious metal catalysts besides size of the crystallites, measured, for example, by x-ray diffraction, is the catalytically active surface of the particles. The catalytically active surface is also referred to as electrochemical surface area (ECSA), because the determination of the catalytically active surface is generally an electrochemical characterization. All measurement methods are based on the quantification of a chemical component being absorbed on the surface of the particles. Chemical components being used are, for example, hydrogen, copper or carbon monoxide. In case of platinum alloy catalysts only the platinum portion is indicated by hydrogen-absorption, whereas carbon monoxide and copper also absorb on the components of the alloy being different from platinum. Thus, the entire surface of the catalyst can be determined. From the difference the portion of the alloying constituents can be achieved.

In case of an alloy of platinum and transition metal, for determining the electrochemical surface area the Cu-UPD (underpotential deposition method of copper) method is suitable, because the atomic radiuses are very similar.

The catalyst according to the invention is preferably used as an electrocatalyst for oxygen reduction reactions. Oxygen reduction reactions are performed, for example, as cathode reactions in fuel cells. Fuel cells using an electrocatalyst for oxygen reduction reactions at the cathode are, for example, polymer electrolyte membrane or proton exchange membrane (PEM) fuel cells or phosphoric acid fuel cells (PAFCs). The inventive catalyst is particularly suitable for the use in phosphoric acid fuel cells, wherein the oxygen reduction reaction is performed in the presence of concentrated H₃PO₄ as electrolyte.

### BRIEF DESCRIPTION OF THE FIGURES

FIG. 1 shows XANES-spectra of Ni-foil, NiO and nickel hydroxide,

FIG. 2 shows XANES-spectra of Ni-foil, NiO and the inventive catalyst,

FIG. 3 shows XANES-spectra of Ni-foil, NiO and PtNi-catalyst according to the state of the art,

FIG. 4 shows EXAFS-spectra of Ni-foil, NiO and PtNi-catalysts according to the invention and according to the state of the art.

### EXAMPLES

### Catalyst Preparation

### PtNi-Catalyst According to the Art (E-Tek)

The PtNi-catalyst as known in the art is described, for example, in WO-A-2006/056470.

For the production of 100 g of 30% by weight Pt₁Ni₁-catalyst on Vulcan XC72 carbon black, 70 g of Vulcan XC72 were suspended in 2.5 l of deionised water in a 4 litre beaker; the carbon was finely dispersed by sonicating for 15 minutes. The slurry was then stirred by means of a magnetic stirrer, and 87 ml of concentrated HNO₃ were added thereto.

36.03 g of platinic acid (corresponding to 23.06 g of Pt) were added to 413 ml of 4.0 M HNO₃ in a separate flask. The solution was stirred until completely dissolution of the platinic acid with formation of reddish colouring. This platinic acid solution was subsequently transferred to the carbon slurry and stirred at ambient temperature for 30 minutes. The beaker was then heated at a rate of 1° C./min up to 70° C., and this temperature was maintained for 1 hour under stirring. The heating was then stopped, and a 15.0 M NaOH solution was added to the slurry at a rate of 10 ml/min, until reaching a pH between 3 and 3.5. The solution was allowed to cool down to room temperature, still under stirring.

34.37 g of Ni(NO₃)₂.6H₂O were dissolved in 150 ml of deionized water, and added to the slurry. After 30 minutes, the pH of the slurry was adjusted to about 8.5 with 0.5 M NaOH, and after 30 more minutes the heating was resumed, raising the temperature to 75° C. at the rate of 1° C./min. The solution was stirred during the whole process, and the pH was controlled at about 8.5 with further additions of NaOH. After reaching 75° C., heating and stirring were both maintained for 1 hour, then the slurry was allowed to cool down to room temperature and filtered. The catalyst cake was washed with 1.5 litres of deionized water, subdivided into 300 ml aliquots, then dried at 125° C. until reaching a moisture content of 2%. The dried cake was ground to 10 mesh granule, and the obtained catalyst was reduced for 30 minutes at 500° C. in hydrogen stream, then sintered at 850° C. in argon for 1 hour and ball-milled to fine powder.

### Catalyst Preparation According to the Invention

The alloy catalysts according to the invention are preferably prepared in a two-step procedure. First, a supported Pt catalyst is prepared. Second, the transition metal component is alloyed with the Pt catalyst.

### Preparation of Carbon-Supported Pt Catalyst

153.1 g of carbon support (Vulcan XC72, CABOT) were dispersed in 5 l deionized water by means of an Ultra-Turrax® dispersing apparatus (15 min, 8000 rpm). 87.6 g platinum nitrate (Heraeus, 57.1 wt % Pt) dissolved in 1 l deionized water, additional 375 ml deionized water and 2125 ml ethanol were added to the carbon dispersion and stirred for an additional half hour. The reaction mixture is then heated at reflux for 5 h and allowed to cool to room temperature. The catalyst dispersion obtained is filtered and washed with hot deionized water until nitrate-free (approx. 30 l). The filter cake is allowed to dry in air until it has a residual moisture content of 35% and comminuted through a 0.4 mm sieve.

XRD analysis showed a Pt crystallite size of 2.0 nm. Pt content on a dry basis 25.4% (i.e. excluding the residual moisture).

### Pt-Alloy Catalysts

### Example 1

### PtNi (1)—(Sample Used for XANES, EXAFS)

38.5 g of the carbon-supported platinum catalyst prepared in the first step are mixed with 10.9 g of nickel acetylacetonate and introduced into the reservoir of a rotary kiln which can be operated continuously. The rotary kiln, including the reservoir, is purged with argon for 1 h (10 l/h).

The rotary kiln has three heating zones set to 350° C., 600° C. and 700° C., respectively from the front to the end. The reaction gas atmosphere is then switched to 5 vol % hydrogen in nitrogen (50 l/h). The conveying speed of the rotary kiln is set to yield ˜20 g catalyst/h with a residence time in the heated zone of approx. 40-45 min.

At the end of the rotary kiln, the catalyst is collected in a reaction flask containing 500 ml deionized water. When all catalyst passed the rotary kiln, the system is cooled under nitrogen flow.

46 g of sulfuric acid are added to the alloy catalyst dispersed in the water (resulting in a 1 M sulfuric acid) and the mixture is heated at 90° C. for 1 h, then filtered and washed with deionized water. The filter cake is then allowed to dry in air until it has a residual moisture content of 35 wt %.

Elemental analyses showed that the catalyst has a composition of 14.9 wt % Pt, 3.2 wt % Ni and 35 wt % H₂O, corresponding to a Pt:Ni stoichiometry of 1.4:1. XRD showed that there are possibly two crystalline phases in the sample, one having 5.2 nm crystallite size (lattice constant 3.724 Å) and the second with 2.9 nm (3.816 Å).

### Example 2

### PtNi (2)

63.4 g of a carbon-supported platinum catalyst prepared in a procedure similar to that outlined above (Pt content on dry basis 30 wt %, residual moisture 29 wt %, i.e. 21.3 wt % Pt in the “wet” catalyst) are mixed with 23.0 g of nickel acetylacetonate and are introduced into the reservoir of a rotary kiln which can be operated continuously. The rotary kiln, including the reservoir, is purged with argon for 1 h (10 l/h).

The three heating zones of the rotary kiln are set to 435° C., 615° C. and 605° C., respectively from the front to the end. The reaction gas atmosphere is then switched to 5 vol % hydrogen in nitrogen (50 l/h). The conveying speed of the rotary kiln is set to yield ˜20 g catalyst/h with a residence time in the heated zone of approx. 70 min.

At the end of the rotary kiln, the catalyst is collected in a reaction flask containing 1 l deionized water. When all catalyst passed the rotary kiln, the system is cooled under nitrogen flow.

The alloy catalyst dispersion is added to 5 l of sulfuric acid (0.5 M) and the mixture is heated at 90° C. for 1 h, then filtered and washed with deionized water (−10 l). The filter cake is then allowed to dry in air overnight.

Elemental analyses showed that the catalyst has a composition of 27 wt % Pt, 4.0 wt % Ni and 2.3 wt % H₂O, corresponding to a Pt:Ni stoichiometry of 2.1:1. XRD showed that there are possibly two crystalline phases in the sample, one having 4.5 nm crystallite size (lattice constant 3.739 Å) and the second with 3.1 nm (3.847 Å).

### Example 3

### PtNi (3)

In the third example, a non-continuous rotary kiln is used.

33.8 g of a carbon-supported platinum catalyst prepared in a procedure similar to that outlined above (Pt content on dry basis 30 wt %, residual moisture 35 wt %, i.e. 19.5 wt % Pt in the “wet” catalyst) are mixed with 18.8 g of nickel acetylacetonate and are introduced into a rotary kiln (HTM Reetz). The rotary kiln is purged with nitrogen for 1 h (15 l/h).

The reaction mixture is then heated for 2 h at 110° C. under nitrogen flow. Then, the gas mixture is switched to 0.8 l/h H₂ and 15 l/h N₂ and the temperature is increased to 210° C. (3 K/min) and held for 4 h. Finally, the temperature is increased to 600° C. (2 K/min) and held for 3 h. The gas atmosphere is switched back to nitrogen flow and the rotary kiln is allowed to cool to room temperature.

The alloy catalyst is kept under inert atmosphere and dispersed in 150 ml deionized water. The catalyst dispersion is then added to 2.5 l of sulfuric acid (0.5 M) and the mixture is heated at 90° C. for 1 h, then filtered and washed with deionized water. The filter cake is then dried in vacuum.

Elemental analyses showed that the catalyst has a composition of 25.7 wt % Pt, 7.0 wt % Ni and 0.5 wt % H₂O, corresponding to a Pt:Ni stoichiometry of 1.1:1. XRD showed PtNi crystallites of 3.1 nm in size (lattice constant 3.737 Å).

### Example 4

### PtCo (1) (Pt₃Co)

35.2 g of the carbon-supported platinum catalyst prepared in the first step are mixed with 11.1 g of cobalt acetylacetonate and are introduced into a rotary kiln (HTM Reetz). The rotary kiln is purged with nitrogen for 1 h (15 l/h).

The reaction mixture is then heated for 2 h at 110° C. under nitrogen flow. Then, the gas mixture is switched to 0.8 l/h H₂ and 15 l/h N₂ and the temperature is increased to 210° C. (3 K/min) and held for 4 h. Finally, the temperature is increased to 600° C. (2 K/min) and held for 3 h. The gas atmosphere is switched back to nitrogen flow and the rotary kiln is allowed to cool to room temperature. For passivation, the gas atmosphere is then switched to 15 l/h N₂ and 3 l/h air, followed by slow increase of the air component up to 15 l/h and no N₂.

The alloy catalyst is dispersed in deionized water and added to 1.6 l of sulfuric acid (0.5 M). The mixture is heated at 90° C. for 1 h, then filtered and washed with deionized water. The filter cake is then allowed to be dried in air.

Elemental analyses showed that the catalyst has a composition of 17.5 wt % Pt, 1.9 wt % Co and 25 wt % H₂O, corresponding to a Pt:Co stoichiometry of 2.8:1. XRD showed there are possibly two crystal phases in the sample: one of tetragonal PtCo (3.1 nm, lattice constant 3.8.11 Å) and a second corresponding to cubic Pt₃Co (1.5 nm, 3.819 Å).

### Example 5

### PtCo (2) (Pt₁Co₁)

18.0 g of a carbon-supported platinum catalyst prepared in a procedure similar to that outlined above (23.2 wt % Pt) are mixed with 8.9 g of cobalt acetylacetonate and are introduced into a rotary kiln (HTM Reetz). The rotary kiln is purged with nitrogen for 1 h (15 l/h).

The reaction mixture is then heated for 2 h at 110° C. under nitrogen flow. Then, the gas mixture is switched to 0.8 l/h H₂ and 15 l/h N₂ and the temperature is increased to 210° C. (3 K/min) and held for 4 h. Finally, the temperature is increased to 600° C. (2 K/min) and held for 3 h. The gas atmosphere is switched back to nitrogen flow and the rotary kiln is allowed to cool to room temperature. For passivation, the gas atmosphere is then switched to 15 l/h N₂ and 3 l/h air, followed by slow increase of the air component up to 15 l/h and no N₂.

The alloy catalyst is dispersed in deionized water and added to 1.5 l of sulfuric acid (0.5 M). The mixture is heated at 90° C. for 1 h, then filtered and washed with deionized water. The filter cake is then dried in vacuum.

Elemental analyses showed that the catalyst has a composition of 25.6 wt % Pt, 5.3 wt % Co and 1.2 wt % H₂O, corresponding to a Pt:Co stoichiometry of 1.5:1. XRD showed crystallite sizes of 2.8 nm (3.875 Å).

### Example 6

### PtV (Pt₄V)

21.1 g of the carbon-supported platinum catalyst prepared in the first step are mixed with 10.5 g of vanadium acetylacetonate and are introduced into a rotary kiln (HTM Reetz). The rotary kiln is purged with nitrogen for 1 h (15 l/h).

The reaction mixture is then heated for 2 h at 110° C. under nitrogen flow. Then, the gas mixture is switched to 0.8 l/h H₂ and 15 l/h N₂ and the temperature is increased to 180° C. (3 K/min) and held for 4 h. Finally, the temperature is increased to 600° C. (2 K/min) and held for 3 h. The gas atmosphere is switched back to nitrogen flow and the rotary kiln is allowed to cool to room temperature.

The alloy catalyst is kept under inert atmosphere and dispersed in 150 ml deionized water. The catalyst dispersion is then added to 1.5 l of sulfuric acid (0.5 M) and the mixture is heated at 90° C. for 1 h, then filtered and washed with deionized water. The filter cake is then allowed to dry in air.

Elemental analyses showed that the catalyst has a composition of 22.0 wt % Pt, 1.5 wt % V and 3 wt % H₂O, corresponding to a Pt:V stoichiometry of 4.4:1. XRD showed a crystallite size of 3.4 nm (3.900 Å).

### XANES-Measurements

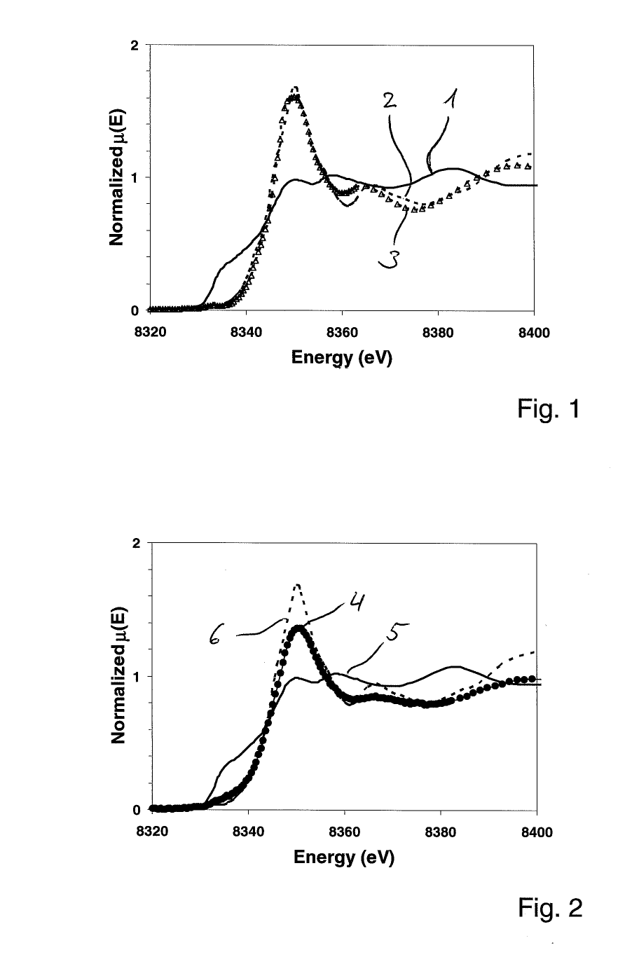

XANES-spectra of Ni-foil, NiO, and nickel hydroxide are shown in FIG. 1. The spectrum of nickel-foil (metallic nickel) is depicted with a solid line 1, the spectrum of NiO with a dashed line 2 and the spectrum of nickel hydroxide with a dashed line 3 with open triangles. Since both oxidized nickel compounds (nickel oxide and nickel hydroxide) exhibit very similar spectra, only the spectrum of NiO will be used for the composition with the alloy catalysts.

The well defined XANES edge feature (“hump”) centered on about 8333 eV in the Ni metal foil scan arise primarily from dipole allowed 1s→4p transition. In the case of the NiO and Ni(OH)₂ samples this XANES edge is absent and instead a weakly defined pre-edge feature is observed around about 8333 eV. This pre-edge feature is due to the dipole forbidden 1s→3d transition. This forbidden transition is made possible due to the hybridization of Ni 3d orbital with that of the 2p electron states from oxygen. This hybridization causes the Ni 3d orbital to assume p-like symmetry and makes possible the dipole forbidden 1s→3d transition.

FIG. 2 shows XANES-spectra at the nickel K-edge (8333 eV) of the inventive catalyst PtNi (1) according to preparation example 1 in comparison to metallic nickel and nickel oxide. The K-edge of the inventive catalyst is shown with plain circles 4, the metallic nickel with a solid line 5 and nickel oxide with a dashed line 6. The measurement of the inventive catalyst is performed in concentrated H₃PO₄ electrolyte. The spectrum of the inventive catalyst is very similar to the oxidized nickel compound, in particular the absence of an absorption edge at 8333 eV as present in metallic nickel. The characteristic peak for oxidized nickel at 8350 eV, not present in metallic nickel, is also distinguishable in the inventive catalyst.

In the case of the inventive PtNi-catalyst, the absence of the edge “hump” feature indicates that the Ni in the inventive PtNi-catalyst has lost its metallic character which is also clearly evident in the Fourier transformed EXAFS spectra of the inventive PtNi catalyst as shown in FIG. 4.

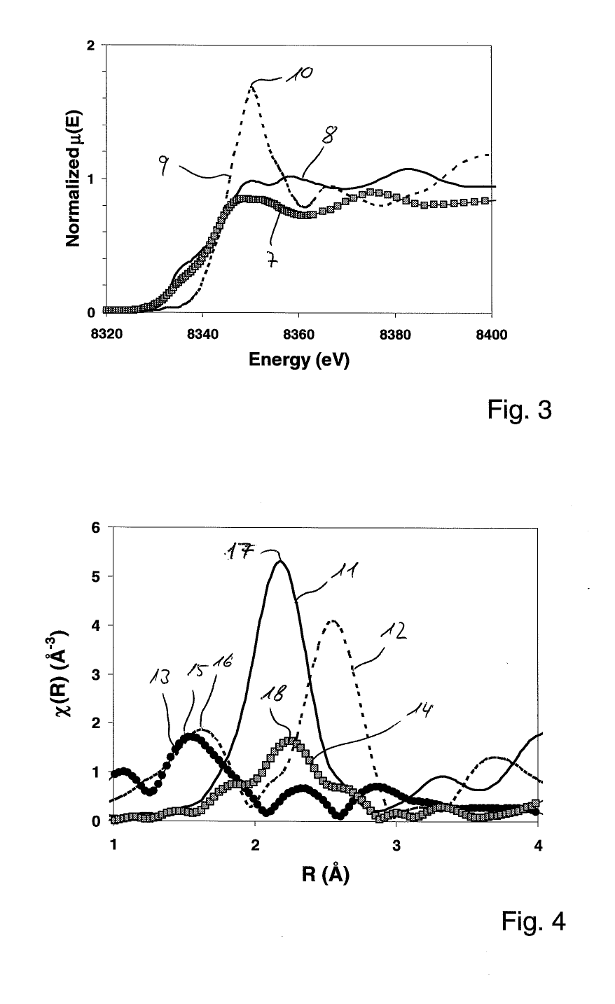

FIG. 3 shows XANES-spectra at the nickel K-edge of a PtNi-catalyst according to the state of the art in comparison to metallic nickel and nickel oxide. The measurements for the PtNi-catalyst according to the state of the art are performed in concentrated H₃PO₄. The spectrum of the PtNi-catalyst according to the state of the art is depicted with plain grey squares 7, the spectrum of metallic nickel with a solid line 8 and the spectrum of nickel oxide with a dashed line 9. The spectrum of the known PtNi-catalyst is very similar to the metallic nickel, in particular shown in the absorption edge at 8333 eV and not exhibiting a distinct peak at 8350 eV as present in oxidized nickel. The distinct peak is depicted with reference number 10.

In the case of PtNi-catalyst according to the state of the art, the existence of metallic Ni is clearly evident from the presence of the edge feature around 8333 eV as can be seen in FIG. 3. This is also corroborated in the Fourier transformed EXAFS spectra where metallic Ni—Ni interaction at about 2.2 Å is only present and Ni—O interaction is absent. This is shown in FIG. 4.

The bond length of nickel in nickel foil, NiO, the inventive PtNi-catalyst according to preparation example 1 and the PtNi-catalyst as known from the art is shown in FIG. 4. The measurements are taken with EXAFS. The spectrum of the metallic nickel in nickel foil is depicted with a solid line 11, the spectrum of nickel oxide with a dashed line 12, the spectrum of the inventive PtNi-catalyst with plain circles 13 and the spectrum of the PtNi-catalyst according the state of the art with plain grey squares 14. From FIG. 4 can be derived that the bond length of the nickel in the inventive catalyst corresponds to the shorter bond distance of the nickel in NiO, see peaks 15, 16, respectively, whereas the bond length of the nickel in the PtNi-catalyst of the state of the art corresponds to the bond length of the nickel expected in a PtNi alloy typified by stable intermetallic composition Pt₃Ni, see peaks 17, 18, respectively.

### Electrochemical Characterization of Pt-Alloy Catalysts

For determination of the catalytically active surface a glass carbon electrode being coated with approximately 15 μg/cm² catalyst is calibrated in a pure electrolyte (0.1 M HClO₄) in the range from 0.05 to 1.2 V with the scan velocity of 10 mV/s. The platinum surface can be calculated by integrating the peak area between 0.05 and 0.4 V, taking into account the amount of charge for a monolayer of absorbed hydrogen of 210 μC/cm². Following, the electrode is polarized in an electrolyte containing copper (0.1 M HClO₄) with 1 mM CuSO₄ at 0.35 V for 120 s. Finally, the electrode is calibrated in a range from 0.35 V to 1.2 V with a scan velocity of 10 mV/s. During the calibration the copper is removed, the electric current being measured corresponds to the originally absorbed amount of copper. The integration of the peak area between 0.05 and 0.4 V taking into account the charge density of a monolayer Cu (420 μC/cm²) allows the determination of the total surface of the catalyst (platinum and nickel).

In the subsequent table the data of three catalysts are shown with respect to the determined platinum surface, total surface and the surface ratio being calculated from the platinum surface and the total surface. The catalysts being compared are a Pt/C-catalyst (E-TEK), a PtNi/C-catalyst (E-TEK) as known from the art as a comparative catalyst and an inventive PtNi/C-catalyst according to preparation example 1.

TABLE 1
Surface data of Pt/C-catalyst, PtNi/C-catalyst (inventive)
and PtNi/C-catalyst as known from the art.

| | ECSA Pt (H_{upd}) | ECSA (Cu_{upd}) | % Pt on |
|---|---|---|---|
| | [m²/g Pt] | [m²/g Pt] | surface |
| Pt/C | 59.6 | 61.7 | 100% |
| PtNi/C (inventive) | 55.1 | 72.4 | 76% |
| PtNi/C (state of the art) | 57.7 | 86.1 | 67% |

Alternatively, the determination of the surface composition can be determined with CO-stripping, as shown in the subsequent table 2. For the determination with CO-stripping the first step comprising measurement in 0.1 M HClO₄ corresponds to the first step as described above. In a next step the electrolyte is washed with CO at 0.05 V for 15 min. Subsequently, the CO is removed from the surface in an argon-saturated electrolyte in a range between 0.05 and 1.2 V.

TABLE 2
Surface measurements of Pt/C-catalyst and an inventive PtNi/C-catalyst
according to preparation example 1 using CO-stripping method

| | ECSA Pt (H_{upd}) | ECSA (CO) | % Pt on |
|---|---|---|---|
| | [m²/g Pt] | [m²/g Pt] | surface |
| Pt/C | 59.6 | 62.3 | 100% |
| PtNi/C (inventive) | 55.1 | 75.6 | 73% |

### Catalytic Activity

The catalytic activity of the catalysts is tested with respect to the oxygen reduction reaction (ORR). A glass carbon electrode being coated with approximately 15 to 25 μg/cm² of the catalyst is measured in HClO₄ (0.1 or 1 M). The electrode rotates with 1 600 rpm (rotating disc electrode, RDE). After a measurement between 0 and 0.95 V in argon-saturated electrolyte the solution is saturated with oxygen and four cyclovoltammograms between 0.05 and 0.95 V (scan rate 20 mV/s) are recorded. The activity is determined from the kinetic electric current at 0.9 V which is calculated from the electric current measured at 0.9 V (i_{0.9V}) and the diffusion limited current (i_{d}), usually normalized with respect to the amount of platinum being applied on the electrode (m_{Pt}), according to the following equation (mass-specific activity):

$${i}_{k} = \frac{{i}_{d} \times {i}_{0.9 V}}{{i}_{d} - {i}_{0.9 V}} \times \frac{1}{{m}_{Pt}}$$

Alternatively, the catalytically active platinum surface (A_{Pt}) being determined by hydrogen absorption as described above can also be used for normalization of the kinetic current, resulting in the so-called surface specific activity.

In an analogous way the oxygen reduction reaction-activity in oxygen-saturated concentrated phosphoric acid as electrolyte can be measured to represent the conditions in a phosphoric acid fuel cell in a better way.

Table 3 shows the mass-specific ORR-activity of the inventive catalyst according to preparation example 1 and the comparative PtNi catalyst as known from the art in HClO₄ and H₃PO₄, respectively.

TABLE 3
ORR-activities of the inventive catalyst
and comparative PtNi catalysts

| | iₖ (0.1M HClO₄) | iₖ (85% H₃PO₄₎ |
|---|---|---|
| | [mA/mg Pt] | [mA/mg Pt] |
| PtNi/C (inventive) | 480 | 6 |
| PtNi/C (state of the art) | 330 | 3 |

From the data shown in table 3 can be recognized that the catalyst according to the invention has an activity being increased by about 40% in HClO₄, which means that the platinum loading is can be decreased by nearly 30% to achieve the same activity.

Under the special experimental conditions of a phosphoric acid fuel cell, in which the catalyst is highly contaminated by phosphate ions, the catalyst according to the invention achieves an activity being twice as good as the catalyst known from the state of the art. Further ORR-data comparing catalysts according to the invention and catalysts as known from the state of the art, for example, as described in WO 2006/056470, show that catalysts according to the invention having different stoichometric compositions, are more active than comparative catalysts as disclosed WO 2006/056470, measured in perchloric acid, or as shown in two cases in concentrated phosphoric acid.

TABLE 4
ORR-activities of inventive Pt-alloy catalysts
of different compositions and known catalysts

| | ECSA (H_{upd}) | iₖ (1M HClO₄) | iₖ (85% H₃PO₄₎ |
|---|---|---|---|
| | [m²/g Pt] | [mA/mg Pt] | [mA/mg Pt] |
| Pt₃Ni₁/C | 36 | 360 | 1.7 |
| (according to WO | | | |
| 2006/056470) | | | |
| Pt₁Ni₁/C | 15 | 135 | |
| (according to WO | | | |
| 2006/056470) | | | |
| Pt₁Ni₁/C | 62 | 573 | 3.1 |
| (inventive, example 1) | | | |
| Pt₂Ni₁/C | 79 | 378 | |
| (inventive, example 2) | | | |
| Pt₁Ni₁/C | 92 | 445 | |
| (inventive, example 3) | | | |
| Pt₃Co₁/C | 118 | 595 | |
| (inventive, example 4) | | | |
| Pt₁Co₁/C | 92 | 571 | |
| (inventive, example 5) | | | |
| Pt₄V₁/C | 103 | 412 | |
| (inventive, example 6) | | | |

1. A catalyst for electro-chemical applications comprising an alloy of platinum and a transition metal, wherein the transition metal has an absorption edge similar to the absorption edge of the transition metal in an oxidic state, measured with x-ray absorption near-edge spectroscopy (XANES) wherein the measurements are performed in concentrated H₃PO₄ electrolyte.

2. The catalyst as claimed in claim 1, wherein the bond length of the transition metal as measured by extended x-ray absorption fine structure (EXAFS) corresponds to the bond length of the transition metal in an oxidic state.

3. The catalyst as claimed in claim 1, wherein the transition metal is selected from the group consisting of nickel, chromium, vanadium, cobalt, manganese, and mixtures or alloys thereof.

4. The catalyst as claimed in claim 1, wherein the molar ratio of platinum to transition metal is in the range from 1 to 5.

5. The catalyst as claimed in claim 1, wherein the crystallites in the alloy have an average size of less than 5 nm.

6. The catalyst as claimed in claim 1, wherein the catalyst further comprises a support.

7. The catalyst as claimed in claim 6, wherein the support is a carbon support.

8. The catalyst as claimed in claim 2, wherein the bond length of the nickel is in the range from 1.5 to 1.8 Å.

9. The catalyst as claimed in claim 1, wherein the transition metal is nickel and the measurements are performed at 0.54 V versus a reversible hydrogen electrode in concentrated H₃PO₄ electrolyte.

10. A process for an oxygen reduction reaction using a catalyst as claimed in claim 1 as electrocatalyst.

11. The process as claimed in claim 10, wherein the oxygen reduction reaction is performed in a fuel cell.

12. The process as claimed in claim 10, wherein the oxygen reduction reaction is performed in the presence of concentrated H₃PO₄ as electrolyte.
